(19) United States
(12) Patent Application Publication
(10) Pub. No.: US 2024/0386734 A1
(43) Pub. Date: Nov. 21, 2024

(54) EXTENDED REALITY-BASED-CONTROL METHOD, APPARATUS, ELECTRONIC DEVICE AND STORAGE MEDIUM

(71) Applicant: Beijing Zitiao Network Technology Co., Ltd., Beijing (CN)

(72) Inventor: Zhipeng LIU, Beijing (CN)

(21) Appl. No.: 18/665,073

(22) Filed: May 15, 2024

(30) Foreign Application Priority Data
May 15, 2023 (CN) 202310544596.0

(51) Int. Cl. G06V 20/70; G06T 7/13; G06T 7/62; G06T 19/00; G06V 10/44; G06V 10/94

(52) U.S. Cl. CPC G06V 20/70; G06T 7/13; G06T 7/62; G06T 19/006; G06V 10/44; G06T 2207/20092; G06T 2219/004; G06V 10/945

(57) ABSTRACT

The disclosure provides an extended reality-based control method, apparatus, electronic device and storage medium. The extended reality-based control method comprises: obtaining an environment image of a real environment; identifying a corner point and/or an edge line of a target object in the environment image based on a vision algorithm; and automatically labeling the target object in the environment image based on the identified corner point and/or edge line.

### CROSS-REFERENCE TO RELATED APPLICATIONS

The present application claims priority to Chinese Patent Application No. 202310544596.0, filed on May 15, 2023 and entitled “extended-reality-based control method, apparatus, electronic device, and storage medium”, the entirety of which is incorporated herein by reference.

### FIELD

The present disclosure relates to the field of computer technologies, and in particular, to an extended-reality-based control method, apparatus, electronic device, and storage medium.

### BACKGROUND

In an extended reality space, such as, a mixed reality scene, a virtual object needs to interact with a reality environment, for example, the virtual object needs to achieve effects such as blocking and collision together with the reality environment, and model information for constructing the reality scene is a basis for realizing interaction. Taking indoor interaction as an example, model information of an indoor wall, a bottom surface, a ceiling, furniture, and other objects needs to be constructed.

### SUMMARY

The present disclosure provides a control method and apparatus based on extended reality, an electronic device and a storage medium.

The present disclosure adopts the following technical solutions.

In some embodiments, the present disclosure provides an extended reality-based control method, including:
obtaining an environment image of a real environment;
identifying a corner point and/or an edge line of a target object in the environment image based on a vision algorithm; and
automatically labeling the target object in the environment image based on the identified corner point and/or edge line.

In some embodiments, the present disclosure provides a control apparatus based on extended reality, including:
an obtaining unit configured to obtain an environment image of a real environment;
an identifying unit configured to identify a corner point and/or an edge line of a target object in the environment image based on a vision algorithm; and
a controlling unit configured to automatically label the target object in the environment image based on the identified corner point and/or edge line.

In some embodiments, the present disclosure provides an electronic device, including: at least one memory and at least one processor:

The memory is configured to store a program code, and the processor is configured to call the program code stored in the at least one memory to execute the described method.

In some embodiments, the present disclosure provides a computer readable storage medium. The computer readable storage medium is configured to store a program code. When run by a processor, the program code causes the electronic device to execute the above method.

Embodiments of the present disclosure provide an extended reality-based control method, comprising: obtaining an environment image of a real environment: identifying a corner point and/or an edge line of a target object in the environment image based on a vision algorithm; and automatically labeling the target object in the environment image based on the identified corner point and/or edge line. The present disclosure realizes automatic labelling, and avoids the problems of large error and low efficiency caused by manual labelling of a user.

### BRIEF DESCRIPTION OF THE DRAWINGS

In conjunction with the accompanying drawings and with reference to the following embodiments, the above and other features, advantages and aspects of the various embodiments of the present disclosure will become more apparent. Throughout the drawings, the same or similar reference numerals indicate the same or similar elements. It should be understood that the drawings are illustrative and the originals and elements are not necessarily drawn to scale.

FIG. 1 is a schematic diagram of using an extended reality device according to an embodiment of the present disclosure.

FIG. 2 is a flowchart of an extended reality-based control method according to an embodiment of the present disclosure.

FIG. 3 is a schematic structural diagram of an electronic device according to an embodiment of the present disclosure.

### DETAILED DESCRIPTION

Embodiments of the present disclosure will be described in more detail below with reference to the accompanying drawings. Although some embodiments of the present disclosure are shown in the drawings, it should be understood that the present disclosure can be implemented in various forms and should not be construed as limited to the embodiments set forth herein. On the contrary, these embodiments are provided for a more thorough and complete understanding of the present disclosure. It should be understood that the drawings and embodiments of the present disclosure are provided for illustrative purposes only and are not intended to limit the scope of protection of the present disclosure.

It should be understood that the various steps described in the method implementation of this disclosure can be executed in different orders and/or in parallel. In addition, the method implementation can include additional steps and/or the steps as shown may be omitted. The scope of this disclosure is not limited in this regard.

The term “including” and its variations as used herein are non-exclusive inclusion, i.e. “including but not limited to”. The term “based on” means “at least partially based on”. The term “one embodiment” means “at least one embodiment”: the term “another embodiment” means “at least one additional embodiment”; and the term “some embodiments” means “at least some embodiments”. Relevant definitions of other terms will be given in the following description.

It should be noted that the concepts of “first” and “second” mentioned in this disclosure are only used to distinguish different apparatuses, modules, or units, but are not used to limit the order or interdependence of the functions performed by these apparatuses, modules, or units.

It should be noted that the modifications of “one” and “a plurality of” mentioned in this disclosure are illustrative but not limiting. Those skilled in the art should understand that unless otherwise indicated in the context, they should be understood as “one or more”.

The names of the messages or information interacted between multiple apparatuses in this public implementation are for illustrative purposes only; which are not intended to limit the scope of these messages or information.

The technical solutions provided by the embodiments of the present disclosure will be described in detail below with reference to the accompanying drawings.

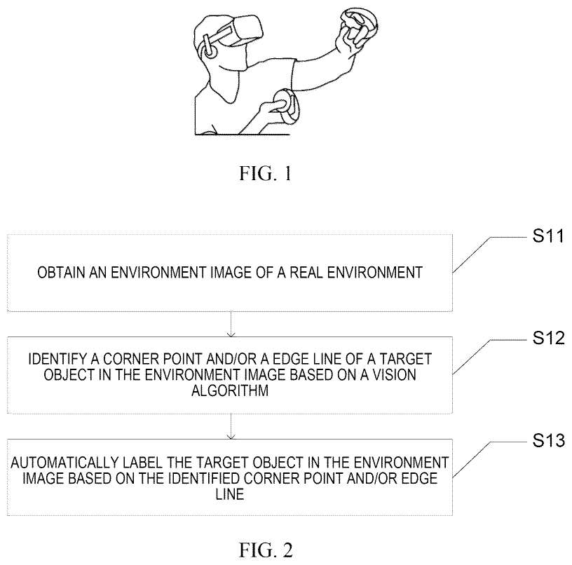

The extended reality may be at least one of virtual reality; extended reality, and mixed reality. Taking mixed reality as an example of the extended reality; as shown in FIG. 1, a user may enter an extended reality space by using an intelligent terminal device such as a head-mounted glasses, and control, in the extended reality space, his own virtual role (Avatar) to perform social interaction, entertainment, learning, remote office, and the like with a virtual role controlled by another user.

The extended reality space may be a simulation environment for real-world, and it may also be a semi-simulated semi-fictional virtual scene, and may also be a pure fictional virtual scene. The virtual scene may be any one of a two-dimensional virtual scene, a 2.5-dimensional virtual scene, and a three-dimensional virtual scene. The embodiment of the present application does not limit the dimension of the virtual scene. For example, the virtual scene may include sky; land, sea, etc., and the land may include environmental elements such as desert and city, etc. The user may control the virtual object to move in the virtual scene.

In an embodiment, in an extended reality space, a user may implement a related interaction operation by operating a device, where the operating device may be a handle, for example, the user performs a related operation control by operating a key of the handle. Of course, in other embodiments, instead of using a controller, a gesture or voice or multimodal control method may be used to control a target object in the extended reality device.

In some embodiments of the present disclosure, the proposed method may be applied to an extended reality device, and may also be applied to a terminal (e.g. a device such as a mobile phone, a tablet, or a computer) communicatively connected with the extended reality device. The extended reality device is a terminal for implementing an extended reality effect, and may generally be provided as a pair of glasses or a head mounted display (HMD), contact lens, so as to realize visual perception and other forms of perception. Of course, the form of is not limited thereto, the extended reality device may be further miniaturized or magnified as necessary.

The extended reality device disclosed in the embodiment of the present disclosure may include, but not limited to, the following types:

A PC terminal extended reality (PCVR) device, by using a PC terminal to perform calculation related to an extended reality function and data output, the external PC terminal extended reality device uses data output by the PC terminal to achieve the extended reality effect.

A mobile extended reality device, which supports setting a mobile terminal (such as a smart phone) in various manners (such as a head-mounted display provided with a dedicated card slot). By means of connecting the mobile terminal in a wired or wireless manner, the mobile terminal performs related calculation related to the extended reality function, and outputs data to the mobile extended reality device, such as viewing an extended reality video through an APP of the mobile terminal.

An all-in-one extended reality device, which has a processor for performing calculation related to a virtual function, and thus having independent extended reality input and output functions. Therefore, there is no need to connect the extended reality device to a PC terminal or a mobile terminal, which has a high degree of freedom in use.

In an extended reality space, a virtual object model may interact with a real environment, such as blocking or collision. Therefore, an object model for an object in the real environment needs to be constructed. When constructing the object model, the object in the real environment needs to be labelled first, and corner points and edge lines of the object in the real environment are indicated, so as to determine information such as shape and size of the object. Usually: a user manually labels boundary information in the real environment, and a system saves the information for constructing a model for the real environment, For example, a user wears an extended reality head-display device, and observes the surrounding physical environment in a video see-through manner, using a control handle to label the boundary of an object in a scene such as a wall and furniture, so as to determine information such as the position, orientation and size of the wall and furniture. This information is configured to construct a model of the spatial scene.

Some embodiments of the present disclosure provide an extended reality-based control method, including:

S11, obtaining an environment image of a real environment.

In some embodiments, the method provided in the present disclosure may be applied to an extended reality device, for example, a mixed reality device. The extended reality device may be a head-mounted extended reality device, and may obtain an environment image of the real environment through a camera on the extended reality device. The environment image may be, for example, an environment image of a surrounding environment for photographing a real space where the current user is located. The environment image may be a video image, that is, it may be a video stream acquiring a real environment, and the acquired environment image may be displayed on the extended reality device for the user to view. In some other embodiments, the environment image may be an environment image shot by and received from an external camera device.

S12: identifying corner points and/or edge lines of a target object in the environment image based on a vision algorithm.

In some embodiments, the environment image may be an indoor environment image, in which an object, such as an indoor wall or furniture, are shot, and the target object may be any object, such as a sofa or a television cabinet. The target object has corner points and edge lines, which constitutes an outline of the target object. A vision algorithm such as a smallest univalue segment assimilating nucleus can be used to identify positions such as the corner points and the edge lines in the environment image.

S13: automatically labeling the target object in the environment image based on the identified corner points and/or edges.

In some embodiments, labeling the target object may include determining a shape, a size, a spatial position, and the like of the target object. A shape profile of the target object can be determined by using corner points and edge lines, and a size of the target object can be determined by using lengths of the edge lines. The contour shape of the target object and the size in each direction are determined based on the identified corner points and edge lines, and the spatial position of the target object can be determined according to the positions of the corner points and edge lines in the real space, thereby labeling is completed.

In some embodiments, if the user manually draws and labels boundaries of an object in the surrounding environment one by one, the steps are cumbersome and the experience is poor. In addition, since the extended reality device occupies both eyes of the user, and the boundaries of the objects in the environment are determined and labeled through the video see-through screen, thus it is prone to generate deviations between labelled positions and the actual positions, and thus leading to inaccurate construction of the environment model. In some embodiments of the present disclosure, information on corner points and a boundary of a target object in an environment image is identified by means of a vision algorithm, so that the target object in the environment image is automatically labelled according to the information on the corner points and the boundary, thereby realizing automatic labeling, and avoiding problems of large error and low efficiency caused by manual labeling of a user.

In some embodiments of the present disclosure, the method further includes constructing a model for the target object in an extended reality space based on the automatically labeled labeling results. In some embodiments, after a target object is labelled, a model for the target object is constructed according to a labeling result of the target object, where the model for the target object is displayed in an extended reality space, and the extended reality space may be a virtual reality space, a mixed reality space, or the like. A user can operate a model for a target object in an extended reality space. The constructed model for a target object may be displayed in an environment image to replace the target object in the environment image, thereby realizing mixed reality. The model for the target object may also be displayed in a purely virtual extended reality space.

In some embodiments of the present disclosure, identifying the corner points and/or the edge lines of the target object in the environment image based on the vision algorithm includes: converting the environment image into a grayscale image: calculating areas of respective regions with univalue segment assimilating nucleus in the grayscale image; and determining the corner points and/or the edge lines of the target object based on the areas of the regions with univalue segment assimilating nucleus.

In some embodiments, a smallest univalue segment assimilating nucleus algorithm may be used to identify corner points and edge lines in the environment image, and the environment image is pre-processed after obtaining the environment image and converting the environment image into a grayscale image, and then an area of each univalue segment assimilating nucleus region is determined based on the grayscale image, then, feature points such as corner points and edge lines are determined based on the areas of the regions with univalue segment assimilating nucleus. This method has a low computational power requirement and a high speed, which is suitable for use in a mobile terminal, and thus avoiding lagging.

In some embodiments of the present disclosure, calculating the areas of respective regions with univalue segment assimilating nucleus in the grayscale image includes: determining a size of a template of a region with univalue segment assimilating nucleus and a grayscale value threshold; and determining an area of pixels in the template having the following grayscale as the area of the univalue segment assimilating nucleus region: a difference between the grayscale and a nucleus point gray value being less than the gray value threshold.

In some embodiments, a template of the regions with univalue segment assimilating nucleus is preset, and a local operation is performed on each pixel of a grayscale image by using the template. Specifically, the template is placed on each pixel of the grayscale image, and the grayscale values of the pixel points covered by the template are compared with the grayscale values of the pixel points corresponding to the center of the template in sequence, when it is determined that a difference value between grayscale values of the two pixel points is less than a grayscale value threshold, it is identified that the pixel point belongs to the univalue segment assimilating nucleus region. All groups of pixels that belong to the univalue segment assimilating nucleus region constitute the area of the univalue segment assimilating nucleus region. In this way: the areas of univalue segment assimilating nucleus region when the template is located on different pixels may be determined.

In some embodiments, corner points and/or edge lines of the target object are determined based on areas of regions with univalue segment assimilating nucleus and a preset threshold.

In some embodiments, when a region with univalue segment assimilating nucleus is close to a position such as a corner point, an edge line, etc., since the interior and exterior colors of the corner point and the edge line may change, the area of the univalue segment assimilating nucleus region may be reduced; therefore, if the area of the univalue segment assimilating nucleus region is larger, it indicates that the number of the points having smaller difference from the nucleus pixel is bigger, and the nucleus point belongs to an inner region; and if the area of the univalue segment assimilating nucleus region is smaller, it indicates that the nucleus points are more likely to be the corner points or the edge lines. In some embodiments, there may be two preset threshold values, which respectively correspond to corner points and edge lines, the threshold value of the corresponding corner points is less than the threshold value of the corresponding edge line. When the difference between the area of a region with univalue segment assimilating nucleus and the threshold value of the corresponding corner point is less than the threshold, it can be considered that the center of the univalue segment assimilating nucleus region is located at the corner point: When the difference between the area of univalue segment assimilating nucleus region and the corresponding edge line is less than the threshold, it may be considered that the center of the univalue segment assimilating nucleus region is located on the edge line. In some embodiments, when the area of the univalue segment assimilating nucleus region is half of the area of the template, it indicates that the nucleus point is located on the edge line, and when the area of the univalue segment assimilating nucleus region is a quarter of the area of the template, it indicates that the nucleus is located on the corner point.

In some embodiments of the present disclosure, automatically labeling the target object in the environment image based on the identified corner points and/or edges includes: obtaining three-dimensional space information about the corner points and/or edge lines of the target object; rendering the corner points and/or edge lines of the target object in the identified environment image based on the three-dimensional space information; and superposing and displaying the rendered corner points and/or edges on the environment image.

In some embodiments, for example, a visual SLAM algorithm may be used to obtain three-dimensional spatial information of corner points and edge lines, where the three-dimensional space information represents a position relationship of the corner points and the edge lines in the three-dimensional space, so as to implement spatial positioning of the corner points and the edge lines.

In some embodiments of the present disclosure, after automatically labeling the target object in the environment image based on the identified corner points and/or edge lines, the method further includes: in response to a confirmation operation on a labeling result obtained after automatically labeling the corner points and/or edge lines of the target object superimposed and displayed on the environment image, saving the labeling result.

In some embodiments, before saving the labeling result, the user may perform a confirmation operation. After viewing the labeling result obtained after automatic labeling, the customer confirms whether the labeling result is correct. If the labeling result is correct, for example, confirmation may be made by clicking through a handle or the like, and the saved labeling result may be stored locally or stored in a server, so that sharing of the labeling result can be implemented between different applications or different devices.

In the following, some specific embodiments of the present disclosure are listed. When a user looks at a wall in an environment by wearing an extended reality head-mounted display device, the video see-through screen is acquired and displayed in the extended reality head-mounted display device. A computer vision algorithm may detect four corners or edge lines of a wall, the corner points and edge lines are rendered in real time by a rendering engine, and are superimposed on the video see-through screen, The user determines, by means of a visual effect, whether the labeled boundary is consistent with a real scene, and if an expectation is met, the user can complete the labeling of the wall by simply clicking and confirming with the control handle. After the user confirms the automatic labeling result, the automatic labeling information is stored by the system and is used to construct model information of the environment scene. The constructed scene model data information may be persistently stored in the local device through the data management module to implement cross-application sharing, or stored in the remote server to implement sharing among different devices.

For another example, when the user looks at furniture in the environment by wearing the extended reality head-mounted display device, the computer vision algorithm module may detect corner points or edge lines of the furniture in the current screen. The corner points and the edge lines are rendered in real time by a rendering engine module, and are superposed on the video see-through screen. The user determines, through a visual effect, whether the labelled boundary is consistent with the real scene. If it is consistent with the real scene, the user only needs to confirm by clicking the control handle to complete labeling of a part of the furniture. When the user view the labelled furniture from different angles of view around the furniture, the whole furniture can be labelled by repeating the above steps.

In some other embodiments, the extended reality device is provided with a camera thereon, and an environment image of a real scene acquired by the camera in real time is used as input data. A computer vision algorithm of a smallest univalue segment assimilating nucleus is used to identify corner points and edge lines on an image, and at the same time, three-dimensional space information of the corner points and the edge lines is obtained, and the generated information is provided to a rendering engine module for real-time rendering and then the rendered information is superimposed on a video sec-through environment screen, The final rendered corner points and edge lines are displayed on the screen of the extended reality device, and the user performs confirmation after viewing the rendered corner points and edge lines, such as, a click confirmation by the control handle, and the confirmation instruction of the user is transmitted to the extended reality device, so as to complete the saving operation of the labeling data.

In some embodiments of the present disclosure, the steps executed by the extended reality device are as follows:
the system performing initialization, completes configuration of relevant modules and parameters, and adjusts the states of all the required modules to be ready;
the camera acquiring data for prepossessing, and converting an environment image acquired by the camera into a grayscale image;
calculating the areas of respective regions with univalue segment assimilating nucleus in the grayscale image includes determining a template size of the univalue segment assimilating nucleus region, setting a threshold t of a grayscale value, and calculating the number of pixels in the template which approximate the grayscale value of a nucleus point (less than t), that is the area of the univalue segment assimilating nucleus region;
extracting a feature point, that is, extracting the feature point by setting a geometric threshold value g of a feature point extraction function, wherein the extracted feature point is a corner point or a constituent point of an edge line;
obtaining three-dimensional information about a feature point, and obtaining the three-dimensional information about the corresponding feature point by means of a visual SLAM algorithm;
the information of the feature points is transmitted to the rendering engine module through the operation management module for visual rendering;
the user confirms the labeled corner points and edge lines through an interaction module;
sending the confirmed edge line information to the data management module for encoding and saving.

Some embodiments of the present disclosure further provide a control apparatus based on extended reality, including:
an obtaining unit configured to obtain an environment image of a real environment;
an identifying unit configured to identify corner points and/or edge lines of a target object in the environment image based on a vision algorithm; and
a controlling unit configured to automatically label the target object in the environment image based on the identified corner points and/or edge lines.

In some embodiments of the present disclosure, information on corner points and a boundary of a target object in an environment image is identified by means of a vision algorithm, so that the target object in the environment image is automatically labelled according to the information of the corner points and the boundary, thereby realizing automatic labeling, and avoiding problems of large error and low efficiency caused by manual labeling of a user.

In some embodiments, taking an extended reality device as an example of the control apparatus, the extended reality device identifies an environment image of a real environment where a user is located, the real environment may be a room where the user is located, and corner points and/or edge lines of the target object in the environment image are identified based on a vision algorithm, and the target object may be furniture or a swing member in the room, such as a television, a clock, a sofa, or the like. The target object is identified labelled on the corner points and/or the edge lines, so as to obtain the size of the target object. After obtaining the size of the target object, a model for the target object may be constructed based on the size of the target object, and the model for the target object may be displayed in the extended reality space (which may be a pure virtual space, or a mixed reality space), and the position of the model for the target object in the extended reality space may correspond to the position thereof in the reality space, Thus, the effect of automatically constructing an accurate model is achieved.

In some embodiments, the control unit is further configured to construct a model for the target object in an extended reality space based on a labeling result automatically labelled.

In some embodiments, identifying the corner points and/or the edge lines of the target object in the environment image based on the vision algorithm includes:
converting the environment image into a grayscale image;
calculating areas of respective regions with univalue segment assimilating nucleus in the grayscale image; and
determining the corner points and/or the edge lines of the target object based on the areas of the regions with univalue segment assimilating nucleus.

In some embodiments, calculating the areas of respective regions with univalue segment assimilating nucleus in the grayscale image includes:
determining a size of a template of a region with univalue segment assimilating nucleus and a grayscale value threshold; and
determining an area of pixels in the template having the following grayscale as the area of the univalue segment assimilating nucleus region: a difference between the grayscale and a nucleus point gray value being less than the gray value threshold.

In some embodiments, determining the corner points and/or the edge lines of the target object based on the areas of the regions with univalue segment assimilating nucleus includes:
determining the corner points and/or the edge lines of the target object based on the areas of the regions with univalue segment assimilating nucleus and a preset threshold.

In some embodiments, automatically labeling the target object in the environment image based on the identified corner points and/or edges includes:
obtaining three-dimensional space information about the corner points and/or edge lines of the target object: rendering the corner points and/or edge lines of the target object in the identified environment image based on the three-dimensional space information; and superposing and displaying the rendered corner points and/or edges on the environment image.

In some embodiments, after automatically labeling the target object in the environment image based on the identified corner points and/or edge lines, the control unit is further configured to, in response to a confirmation operation on a labeling result obtained after automatically labeling the corner points and/or edge lines of the target object superimposed and displayed on the environment image, save the labeling result.

For the apparatus embodiments, since they basically correspond to the method embodiments, for the relevant parts, reference may be made to the partial description of the method embodiments. The apparatus embodiments described above are merely exemplary; and modules described as separate modules may or may not be separated. A part or all of the modules may be selected according to actual needs to achieve the objectives of the technical solutions of the embodiments. Those skilled in the art can understand and implement the present application without creative efforts.

The method and apparatus of the present disclosure are described above based on embodiments and application examples. In addition, the present disclosure further provides an electronic device and a computer readable storage medium, which are described below.

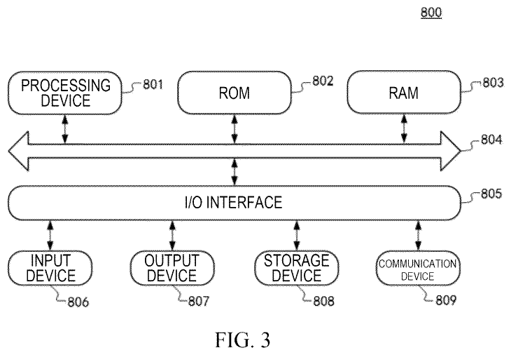

Referring now to FIG. 3, it is a structural schematic diagram of an electronic device (e.g., an terminal device or a server) 800 suitable for implementing the embodiment of the present disclosure. The terminal device in the embodiment of the present disclosure may include but is not limited to mobile terminals such as mobile phones, laptops, digital broadcast receivers. PDAs (Personal Digital Assistants). PADs (tablet computers). PMPs (portable multimedia players), car-mounted terminals (such as car navigation terminals), etc. and fixed terminals such as digital televisions (TV), desktop computers, etc., or may include extended reality devices, such as virtual reality devices, augmented reality devices or mixed reality device. The electronic device shown in the drawing is only an example and should not bring any limitation on the functionality and scope of use of the embodiment of the present disclosure.

The electronic device 800 may include a processing device (such as a central processing unit, graphics processing unit, etc.) 801, which may perform various appropriate actions and processes based on programs stored in Read-Only Memory (ROM) 802 or loaded from storage device 808 into Random Access Memory (RAM) 803. In the RAM 803, various programs and data necessary for the operation of the electronic device 800 are also stored. The processing device 801. ROM 802, and RAM 803 are connected to each other through a bus 804. An Input/Output I/O interface 805 is also connected to the bus 804.

Generally, the following devices can be connected to I/O interface 805: input devices 806 including, for example, touch screens, touchpads, keyboards, mice, cameras, microphones, accelerometers, gyroscopes, etc.: output devices 807 including liquid crystal displays (LCDs), speakers, vibrators, etc.; storage devices 808 including magnetic tapes, hard disks, etc.; and a communication device 809. The communication device 809 may allow the electronic device 800 to communicate with other devices wirelessly or wirelessly to exchange data. Although the drawing shows an electronic device 800 with multiple devices, it shall be understood that it is not required to implement or have all of the devices shown. More or fewer devices can be implemented or provided instead.

In particular, according to embodiments of the present disclosure, the process described above with reference to the flowchart can be implemented as a computer software program. For example, an embodiment of the present disclosure includes a computer program product that includes a computer program carried on a computer-readable medium, where the computer program includes program code for performing the method shown in the flowchart. In such an embodiment, the computer program can be downloaded and installed from a network through the communication device 809, or installed from the storage device 808, or installed from the ROM 802. When the computer program is executed by the processing device 801, the above functions defined in the method of the embodiment of the present disclosure are performed.

It should be noted that the computer-readable medium described above can be a computer-readable signal medium or a computer-readable storage medium, or any combination thereof. The computer-readable storage medium can be, for example, but not limited to, an electrical, magnetic, optical, electromagnetic, infrared, or semiconductor system, apparatus, or device, or any combination thereof. Specific examples of computer-readable storage media may include but are not limited to: an electrical connection with one or more wires, a portable computer disk, a hard disk, random access memory (RAM), read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, a computer-readable medium may be any tangible medium containing or storing a program that can be used by an instruction execution system, apparatus, or device, or can be used in combination with an instruction execution system, apparatus, or device. In the present disclosure, a computer-readable signal medium can include a data signal propagated in baseband or as part of a carrier wave, which carries computer-readable program code therein. Such propagated data signals may take many forms, including but not limited to electromagnetic signals, optical signals, or any suitable combination thereof. A computer-readable signal medium may also be any computer-readable medium other than a computer-readable medium, which can send, propagate, or transmit programs for use by or in conjunction with instruction execution systems, apparatus, or devices. The program code contained on the computer-readable medium may be transmitted using any suitable medium, including but not limited to: wires, optical cables. RF (radio frequency), etc., or any suitable combination thereof.

In some embodiments, clients and servers can communicate using any currently known or future developed network protocol such as HTTP (HyperText Transfer Protocol), and can be interconnected with any form or medium of digital data communication (such as communication networks). Examples of communication networks include local area networks (“LANs”), wide area networks (“WANs”), internetworks (such as the Internet), and end-to-end networks (such as ad hoc end-to-end networks), as well as any currently known or future developed networks.

The computer-readable medium can be included in the electronic device, or it can exist alone without being assembled into the electronic device.

The above-mentioned computer-readable medium carries one or more programs, and when the above-mentioned one or more programs are executed by the electronic device, the electronic device: performs the method of the disclosure as above.

Computer program codes for performing the operations of the present disclosure may be written in one or more programming languages or a combination thereof, including Object Oriented programming languages—such as Java. Smalltalk. C++, and also conventional procedural programming languages—such as “C” or similar programming languages. The program code may be executed entirely on the user's computer, partially executed on the user's computer, executed as a standalone software package, partially executed on the user's computer and partially on a remote computer, or entirely on a remote computer or server. In the case of involving a remote computer, the remote computer may be any kind of network—including local area network (LAN) or wide area network (WAN)—connected to the user's computer, or may be connected to an external computer (e.g., through an Internet service provider to connect via the Internet).

The flowcharts and block diagrams in the accompanying drawings illustrate the architecture, functions, and operations of possible implementations of the system, method, and computer program product according to various embodiments of the present disclosure. In this regard, each block in a flowchart or block diagram may represent a module, program segment, or portion of code that contains one or more executable instructions for implementing a specified logical function. It should also be noted that in some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

The units described in the embodiments of the present disclosure may be implemented by means of software or hardware, and the name of the unit does not constitute a limitation on the unit itself in a certain case.

The functions described herein above can be performed at least in part by one or more hardware logic components. For example, without limitation, exemplary types of hardware logic components that may be used include: Field Programmable Gate Arrays (FPGAs). Application Specific Integrated Circuits (ASICs). Application Specific Standard Parts (ASSPs). System on Chip (SOCs). Complex Programmable Logic Devices (CPLDs), and so on.

In the context of this disclosure, a machine-readable medium can be a tangible medium that may contain or store programs for use by or in conjunction with instruction execution systems, apparatuses, or devices. A machine-readable medium may be a machine-readable signal medium or a machine-readable storage medium. A c machine-readable medium may include, but are not limited to, electronic, magnetic, optical, electromagnetic, infrared, or semiconductor systems, apparatuses, or devices, or any suitable combination thereof. Specific examples of the machine-readable medium may include electrical connections based on one or more wires, portable computer disks, hard disks, random access memory (RAM), read-only memory (ROM), erasable programmable read-only memory (EPROM or flash memory), optical fibers, convenient compact disk read-only memory (CD-ROM), optical storage devices, magnetic storage devices, or any suitable combination thereof.

According to one or more embodiments of the present disclosure, there is provided an extended reality-based control method, including:
obtaining an environment image of a real environment;
identifying corner points and/or edge lines of a target object in the environment image based on a vision algorithm; and
automatically labeling the target object in the environment image based on the identified corner points and/or edge lines.

According to one or more embodiments of the present disclosure, there is provided an extended reality-based control method, further including:
constructing a model for the target object in an extended reality space based on a labeling result of automatic labeling.

According to one or more embodiments of the present disclosure, the control method based on extended reality is provided, and identifying the corner points and/or the edge lines of the target object in the environment image based on the vision algorithm includes:
converting the environment image into a grayscale image;
calculating areas of respective regions with univalue segment assimilating nucleus in the grayscale image; and
determining the corner points and/or the edge lines of the target object based on the areas of the regions with univalue segment assimilating nucleus.

According to one or more embodiments of the present disclosure, an extended reality-based control method is provided, and calculating the areas of respective regions with univalue segment assimilating nucleus in the grayscale image includes:
determining a size of a template of a region with univalue segment assimilating nucleus and a grayscale value threshold; and
determining an area of pixels in the template having the following grayscale as the area of the univalue segment assimilating nucleus region: a difference between the grayscale and a nucleus point gray value being less than the gray value threshold.

According to one or more embodiments of the present disclosure, an extended reality-based control method is provided and determining the corner points and/or the edge lines of the target object based on the areas of the regions with univalue segment assimilating nucleus includes:
determining the corner points and/or the edge lines of the target object based on the areas of the regions with univalue segment assimilating nucleus and a preset threshold.

According to one or more embodiments of the present disclosure, an extended reality-based control method is provided: automatically labeling the target object in the environment image based on the identified corner points and/or edges includes:
obtaining three-dimensional space information about the corner points and/or edge lines of the target object: rendering the corner points and/or edge lines of the target object in the identified environment image based on the three-dimensional space information; and superposing and displaying the rendered corner points and/or edges on the environment image.

According to one or more embodiments of the present disclosure, an extended reality-based control method is provided. After automatically labeling the target object in the environment image based on the identified corner points and/or edge lines, the method further includes:
in response to a confirmation operation on a labeling result obtained after automatically labeling the corner points and/or edge lines of the target object superimposed and displayed on the environment image, saving the labeling result.

According to one or more embodiments of the present disclosure, there is provided a control apparatus based on extended reality, including:
an obtaining unit configured to obtain an environment image of a real environment;
an identifying unit configured to identify corner points and/or edge lines of a target object in the environment image based on a vision algorithm; and
a controlling unit configured to automatically label the target object in the environment image based on the identified corner points and/or edge lines.

According to one or more embodiments of the present disclosure, there is provided an electronic device, including: at least one memory and at least one processor;
wherein the at least one memory is configured to store a program code, and the at least one processor is configured to call the program code stored in the at least one memory to execute the method of any one of the methods described above.

According to one or more embodiments of the present disclosure, a computer-readable storage medium is provided, the computer-readable storage medium is configured to store a program code, and when run by a processor, the program code causes the electronic device to execute the method to perform any one of the methods described above.

The above description is only embodiments of this disclosure and an explanation of the technical principles used. Those skilled in the art should understand that the scope of the disclosure involved in this disclosure is not limited to technical solutions composed of specific combinations of the above technical features, but should also covers other technical solutions formed by arbitrary combinations of the above technical features or their equivalent features without departing from the above disclosure concept. For example, technical solutions formed by replacing the above features with (but not limited to) technical features with similar functions disclosed in this disclosure.

In addition, although multiple operations are depicted in a specific order, this should not be understood as requiring these operations to be performed in the specific order shown or in a sequential order. In certain environments, multitasking and parallel processing may be advantageous. Similarly, although multiple implementation details are included in the above discussion, these should not be construed as limiting the scope of the present disclosure. Some features described in the context of individual embodiments can also be implemented in combination in a single embodiment. Conversely, multiple features described in the context of a single embodiment can also be implemented in multiple embodiments separately or in any suitable sub-combination.

Although the subject matter has been described in language specific to structural features and/or methodological logical actions, it should be understood that the subject matter defined in the appended claims is not necessarily limited to the specific features or actions described above. On the contrary, the specific features and actions described above are merely example forms of implementing the claims.

What is claimed is:

1. An extended reality-based control method, comprising:
obtaining an environment image of a real environment;
identifying a corner point and/or an edge line of a target object in the environment image based on a vision algorithm; and
automatically labeling the target object in the environment image based on the identified corner point and/or edge line.

2. The method of claim 1, further comprising:
constructing a model for the target object in an extended reality space based on a labeling result of the automatically labeling.

3. The method of claim 1, wherein identifying the corner point and/or the edge line of the target object in the environment image based on the vision algorithm comprises:
converting the environment image into a grayscale image;
calculating areas of respective regions with univalue segment assimilating nucleus in the grayscale image; and
determining the corner point and/or the edge line of the target object based on the areas of the regions with univalue segment assimilating nucleus.

4. The method of claim 3, wherein calculating the areas of respective regions with univalue segment assimilating nucleus in the grayscale image comprises:
determining a size of a template of a region with univalue segment assimilating nucleus and a grayscale value threshold; and
determining an area of pixels in the template having the following grayscale as the area of the region with univalue segment assimilating nucleus: a difference between the grayscale and a nucleus point gray value being less than the gray value threshold.

5. The method of claim 4, wherein determining the corner point and/or the edge line of the target object based on the areas of the regions with univalue segment assimilating nucleus comprises:
determining the corner point and/or the edge line of the target object based on the areas of the regions with univalue segment assimilating nucleus and a preset threshold.

6. The method of claim 1, wherein automatically labeling the target object in the environment image based on the identified corner point and/or edge comprises:
obtaining three-dimensional space information about the corner point and/or edge line of the target object: rendering the corner point and/or edge line of the target object in the identified environment image based on the three-dimensional space information; and superposing and displaying the rendered corner point and/or edge on the environment image.

7. The method of claim 1, wherein after automatically labeling the target object in the environment image based on the identified corner point and/or edge line, the method further comprises:
in response to a confirmation operation on a labeling result obtained after automatically labeling the corner point and/or edge line of the target object superimposed and displayed on the environment image, saving the labeling result.

8. An electronic device, comprising:
at least one memory and at least one processor;
wherein the at least one memory is configured to store a program code, and the at least one processor is configured to call the program code stored in the at least one memory to execute a method comprising:
obtaining an environment image of a real environment;
identifying a corner point and/or an edge line of a target object in the environment image based on a vision algorithm; and
automatically labeling the target object in the environment image based on the identified corner point and/or edge line.

9. The device of claim 8, wherein the method further comprises:
constructing a model for the target object in an extended reality space based on a labeling result of the automatically labeling.

10. The device of claim 8, wherein identifying the corner point and/or the edge line of the target object in the environment image based on the vision algorithm comprises:
converting the environment image into a grayscale image;
calculating areas of respective regions with univalue segment assimilating nucleus in the grayscale image; and
determining the corner point and/or the edge line of the target object based on the areas of the regions with univalue segment assimilating nucleus.

11. The device of claim 10, wherein calculating the areas of respective regions with univalue segment assimilating nucleus in the grayscale image comprises:
determining a size of a template of a region with univalue segment assimilating nucleus and a grayscale value threshold; and
determining an area of pixels in the template having the following grayscale as the area of the region with univalue segment assimilating nucleus: a difference between the grayscale and a nucleus point gray value being less than the gray value threshold.

12. The device of claim 11, wherein determining the corner point and/or the edge line of the target object based on the areas of the regions with univalue segment assimilating nucleus comprises:
determining the corner point and/or the edge line of the target object based on the areas of the regions with univalue segment assimilating nucleus and a preset threshold.

13. The device of claim 8, wherein automatically labeling the target object in the environment image based on the identified corner point and/or edge comprises:
obtaining three-dimensional space information about the corner point and/or edge line of the target object: rendering the corner point and/or edge line of the target object in the identified environment image based on the three-dimensional space information; and superposing and displaying the rendered corner point and/or edge on the environment image.

14. The device of claim 8, wherein after automatically labeling the target object in the environment image based on the identified corner point and/or edge line, the method further comprises:
in response to a confirmation operation on a labeling result obtained after automatically labeling the corner point and/or edge line of the target object superimposed and displayed on the environment image, saving the labeling result.

15. A non-transitory computer readable storage medium, wherein the computer readable storage medium is configured to store a program code, and when run by a processor, the program code causes the electronic device to execute a method comprising:
obtaining an environment image of a real environment;
identifying a corner point and/or an edge line of a target object in the environment image based on a vision algorithm; and
automatically labeling the target object in the environment image based on the identified corner point and/or edge line.

16. The computer readable storage medium of claim 15, wherein the method further comprises:
constructing a model for the target object in an extended reality space based on a labeling result of the automatically labeling.

17. The computer readable storage medium of claim 15, wherein identifying the corner point and/or the edge line of the target object in the environment image based on the vision algorithm comprises:
converting the environment image into a grayscale image;
calculating areas of respective regions with univalue segment assimilating nucleus in the grayscale image; and
determining the corner point and/or the edge line of the target object based on the areas of the regions with univalue segment assimilating nucleus.

18. The computer readable storage medium of claim 17, wherein calculating the areas of respective regions with univalue segment assimilating nucleus in the grayscale image comprises:
determining a size of a template of a region with univalue segment assimilating nucleus and a grayscale value threshold; and
determining an area of pixels in the template having the following grayscale as the area of the region with univalue segment assimilating nucleus: a difference between the grayscale and a nucleus point gray value being less than the gray value threshold.

19. The computer readable storage medium of claim 17, wherein determining the corner point and/or the edge line of the target object based on the areas of the regions with univalue segment assimilating nucleus comprises:
determining the corner point and/or the edge line of the target object based on the areas of the regions with univalue segment assimilating nucleus and a preset threshold.

20. The computer readable storage medium of claim 15, wherein automatically labeling the target object in the environment image based on the identified corner point and/or edge comprises:
obtaining three-dimensional space information about the corner point and/or edge line of the target object: rendering the corner point and/or edge line of the target object in the identified environment image based on the three-dimensional space information; and superposing and displaying the rendered corner point and/or edge on the environment image.
